(19) United States
(12) Patent Application Publication
(10) Pub. No.: US 2026/0204042 A1
(43) Pub. Date: Jul. 16, 2026

(54) MARKER DETECTION DEVICE, MONITORING SYSTEM, AND METHODS THEREOF

(71) Applicant: MINEBEA MITSUMI Inc., Nagano (JP)

(72) Inventors: Chuting WANG, Nagano (JP); Chiaki OKIHARA, Nagano (JP); Shigemi MASUDA, Nagano (JP)

(21) Appl. No.: 18/865,821

(22) PCT Filed: May 8, 2023
(86) PCT No.: PCT/JP2023/017311

§ 371 Date: Nov. 14, 2024

(30) Foreign Application Priority Data
May 18, 2022 (JP) 2022-081497

(51) Int. Cl. G06V 10/46; G06T 7/11; G06V 10/60

(52) U.S. Cl. CPC G06V 10/462; G06T 7/11; G06V 10/60; G06V 2201/07

(57) ABSTRACT

To detect a marker at high speed. A marker detection device includes a storage configured to store, as a registered descriptor, a feature descriptor generated from an image in which a marker is captured, the marker including a plurality of colors arranged in one direction; an image acquisition unit configured to acquire a one-dimensional image; a feature point detection unit configured to detect a feature point from the one-dimensional image; a feature description unit configured to generate, as an observation descriptor, the feature descriptor that represents a luminance change of a region including the feature point; and a marker determination unit configured to determine whether the marker is included in the one-dimensional image, based on a matching result between the registered descriptor and the observation descriptor.

### TECHNICAL FIELD

The present disclosure relates to a marker detection device, a monitoring system, and methods thereof.

### BACKGROUND

There are monitoring systems for inspecting structures such as tunnels. In inspections using monitoring systems, inspection vehicles equipped with the monitoring systems measure deformation or the like of the structures within predetermined monitoring areas, while the inspection vehicles are traveling within the structures. This allows for the determination of whether abnormalities have occurred in the structures.

For example, Patent Document 1 discloses a catenary wire fitting inspection system for acquiring, from a line sensor camera, an image of a specific catenary wire fitting that is attached to a catenary wire, and the line sensor camera is installed on a roof of a railway vehicle.

### RELATED-ART DOCUMENTS

### Patent Documents

Patent Document 1: Japanese Patent No. 5423567

### SUMMARY

### Problem to be Solved by the Invention

In order to inspect the structures efficiently, it is desirable to operate an inspection vehicle during service. In this case, it is necessary to operate the inspection vehicle at high speed so as not to disturb the service. In order to recognize a monitoring area through the inspection vehicle operating at the high speed, it is necessary to rapidly detect a marker indicating the monitoring area.

In view of the above technical problem, one aspect of the present invention aims to detect a marker at high speed.

### Means for Solving the Problem

In order to solve the above problem, a marker detection device in one aspect of the present invention includes a storage configured to store, as a registered descriptor, a feature descriptor generated from an image in which a marker is captured, the marker including a plurality of colors arranged in one direction; an image acquisition unit configured to acquire a one-dimensional image; a feature point detection unit configured to detect a feature point from the one-dimensional image; a feature description unit configured to generate, as an observation descriptor, a feature descriptor that represents a luminance change of a region including the feature point; and a marker determination unit configured to determine whether the marker is included in the one-dimensional image, based on a matching result between the registered descriptor and the observation descriptor.

### Effects of the Invention

In one aspect of the present invention, a marker can be detected at high speed.

### BRIEF DESCRIPTION OF THE DRAWINGS

FIG. 1 is a conceptual diagram showing an example of a monitoring system.

FIG. 2 is a conceptual diagram showing an example of tunnel convergence measurement.

FIG. 3 is a conceptual diagram showing an example of a line scan camera.

FIG. 4 is a conceptual diagram showing an example of a color marker.

FIG. 5 is a conceptual diagram showing an example of a method of imaging the color marker.

FIG. 6 is a diagram showing an example of the overall configuration of the monitoring system.

FIG. 7 is a diagram showing an example of a hardware configuration of a computer.

FIG. 8 is a diagram showing an example of a functional configuration of the monitoring system.

FIG. 9 is a diagram showing an example of a monitoring method.

FIG. 10 show an example of a blurred image generation process.

FIG. 11 show an example of the relationship between octaves.

FIG. 12 show an example of a feature point detection process.

FIG. 13 show a specific example of a difference image generation process.

FIG. 14 show a specific example of an extremum search process.

FIG. 15 show an example of a feature descriptor generation process.

FIG. 16A is a diagram for describing the distribution into a histogram.

FIG. 16B is a diagram for describing a feature descriptor.

FIG. 17(A) is a diagram showing the relationship between a first neighboring point and a second neighboring point in an image capturing the marker. FIG. 17(B) is a diagram showing the relationship between the first neighboring point and the second neighboring point in an image in which no marker is captured.

FIG. 18 shows an example of a feature descriptor matching process.

FIG. 19 show a specific example of a center position estimation process.

FIG. 20(A) shows a center position estimating result in the image capturing the marker. FIG. 20(B) shows a center position estimation result in an image in which no marker is captured.

FIG. 21 show an example of a marker determination process.

### MODE FOR CARRYING OUT THE INVENTION

Embodiments of the present invention will be described below with reference to the accompanying drawings. In the present specification and the drawings, components having substantially the same functional configuration are denoted by the same numerals, and redundant description is omitted.

### [Overview]

In recent years, image processing technology has become increasingly important with the development of autonomous driving technology and artificial intelligence (AI) technology. Among these technologies, marker detection technology has been known as an approach to confirm whether a marker specified as a detection object exists in a specified image. The marker detection technology is used for purposes such as triggering signals to turn on/off, estimating self-position, or image matching. In particular, when detecting a marker with a fast-moving object, it is necessary to accelerate the image processing.

For example, in a structure such as a railway tunnel, it is important to perform preventive maintenance to check for abnormalities on a daily basis. Tunnel deformation is an important inspection item because the tunnel deformation may occur due to a load from an upper part, and ground pressure or the like from a lower part. When a tunnel deformation speed is high, countermeasures must be taken immediately to maintain tunnel function.

Conventionally, tunnel inspections have been performed manually by humans entering tracks outside of railway operating hours. In recent years, various monitoring systems have been developed from the viewpoint of efficiency improvement. Ideally, it is desirable that a system can be mounted on a railway vehicle in normal operation, and that the tunnel deformation can be monitored routinely and automatically.

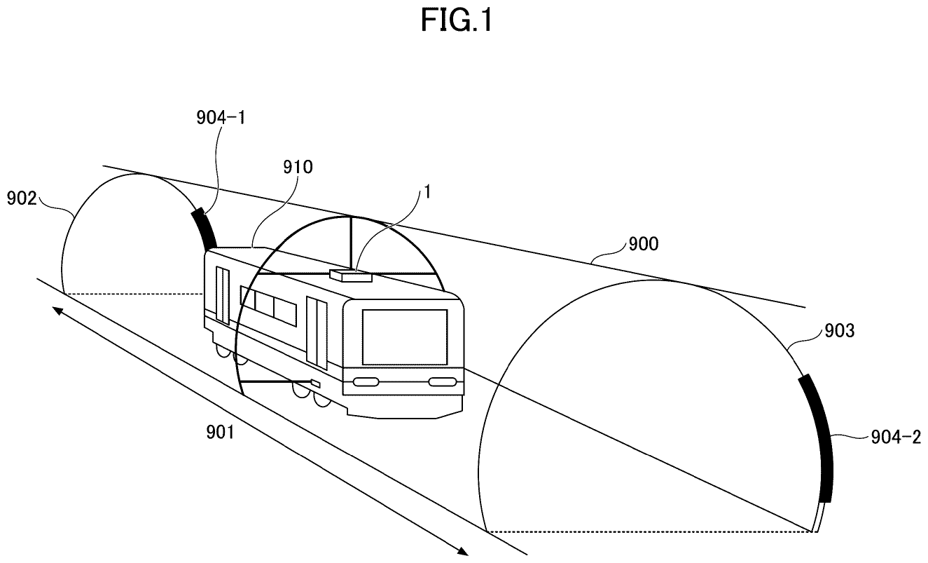

FIG. 1 is a conceptual diagram showing an example of a monitoring system. As shown in FIG. 1, a monitoring system 1 is mounted outside a ceiling or the like of an inspection vehicle 910. The inspection vehicle 910 measures convergence or the like of a tunnel 900, while traveling through a monitoring area 901 that is set in the tunnel 900. In the monitoring area 901, markers 904-1 and 904-2 are installed at a start point 902 and an end point 903, respectively, such that the monitoring system 1 can recognize the monitoring area 901.

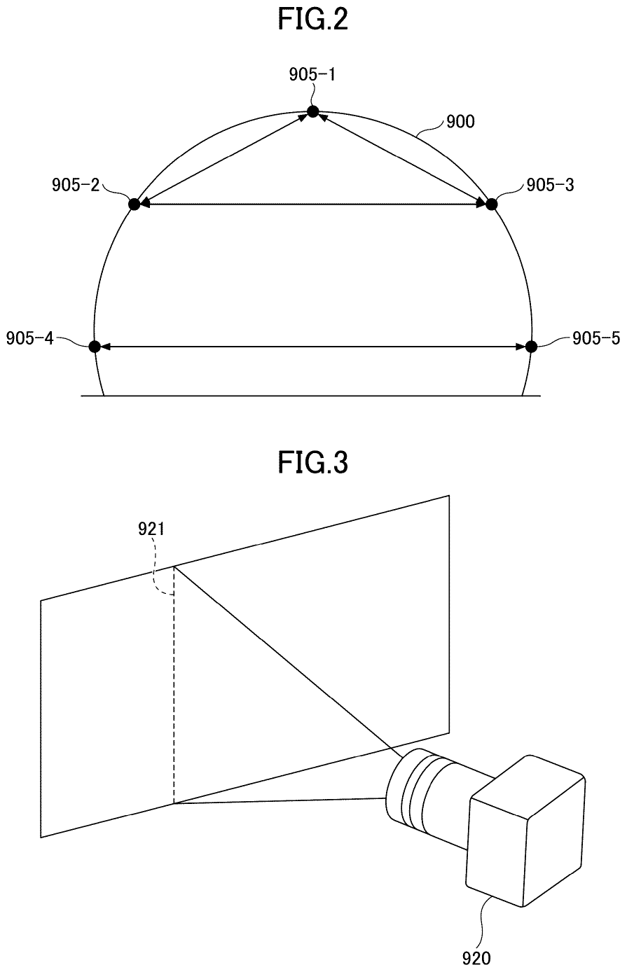

FIG. 2 is a conceptual diagram showing an example of tunnel convergence measurement. As shown in FIG. 2, in the convergence measurement, displacement data of five measuring points 905-1 to 905-5 is measured in the cross section of the tunnel 900, and the deformation of the tunnel 900 is evaluated based on four measuring lines, each of which connects two given measuring points 905.

The monitoring system that monitors a structure while moving, as described above, is called a “traveling monitoring system.” In addition to measurement accuracy, the traveling monitoring system requires accuracy with regard to measurement objectives as follow. 1. Measurement is performed only in the monitoring area that requires inspection (i.e., useless data is not taken). 2. The same monitoring area is measured every time (i.e., a correct measurement target is repeatedly monitored).

Regarding the item 1 above, in a monitoring system that keeps collecting data over a certain time period, there may be a problem that it takes a long time to process a large amount of acquired data. For example, data processing is necessary, such as aligning the monitoring area each time measurement is performed, or extracting necessary data portions.

Regarding the item 2 above, there may be a problem that it is difficult for the monitoring system itself to specify its position and start measurement in the same monitoring area. For example, in a method using radio waves such as GPS (Global Positioning System), WiFi (registered trademark), or RFID (Radio Frequency Identification), it is difficult to start and stop the measurement in the same monitoring area each time, because the accuracy of position determination is about several meters.

In one embodiment according to the present invention, in order to solve the problem, a marker detection device using one-dimensional image data, and a monitoring system using the marker detection device are provided. In one embodiment, as an example, marker determination that uses a color marker and a color line scan camera is performed. However, any other combination capable of obtaining one-dimensional data may be used for marker determination. For example, laser displacement data, an inertial measurement device, or the like can be used.

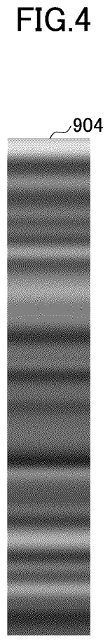

FIG. 3 is a conceptual diagram showing an example of a line scan camera. As shown in FIG. 3, a line scan camera 920 is a digital camera that defines an imaging area with a linear imaging line 921 that is oriented in a predetermined one direction.

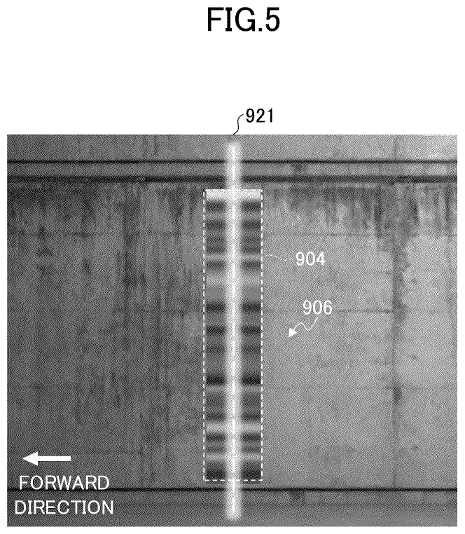

FIG. 4 is a conceptual diagram showing an example of the marker. As shown in FIG. 4, a marker 904 has a plurality of colors arranged in one direction. It is preferable that the colors of the marker 904 change complexly. In particular, it is preferable that the marker has a characteristic that differs from a color pattern that frequently appears on a structure wall surface where the marker 904 is installed.

As the color changes of the marker become more complex in one direction, a unique feature point is more easily created. For this reason, it is preferable that the marker is configured such that, around the feature point, luminance values of respective primary colors change nonlinearly and as differently from one another as possible. When a color line scan camera captures an image of an RGB color model, the colors may be determined such that at least one of the RGB components changes nonlinearly.

As shown in FIG. 1, in the monitoring system 1 according to one embodiment, the markers 904-1 and 904-2 are placed on the tunnel wall surface at the start point 902 and the end point 903 of the monitoring area 901, and a tunnel wall surface is continuously imaged from the traveling inspection vehicle 910. The monitoring system 1 retrieves one-dimensional color image data from the camera, and determines whether a pre-stored correct marker is included in the one-dimensional image.

If the image data includes the marker placed at the start point 902, the monitoring system 1 starts the convergence measurement of the tunnel 900. On the other hand, if the image data includes the marker placed at the end point 903, the monitoring system 1 stops the convergence measurement of the tunnel 900.

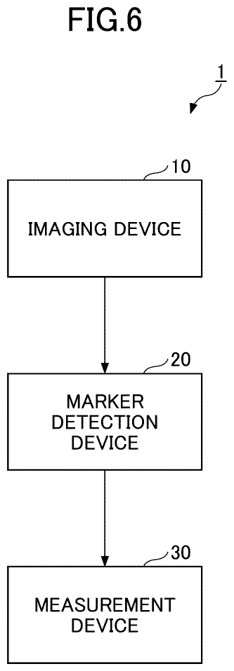

FIG. 5 is a diagram showing an example of a method for imaging the color marker. As shown in FIG. 5, the marker 904 is placed on a wall surface 906 of the tunnel. The marker 904 is placed such that a color changing direction is perpendicular to a forward direction of the inspection vehicle. Similarly, the imaging line 921 of the line scan camera is set so as to be perpendicular to the forward direction of the inspection vehicle. The inspection vehicle moves in a horizontal direction with respect to the ground, and thus the color changing direction of the marker 904 and the imaging line 921 of the line scan camera are set in a vertical direction with respect to the ground.

In the example of FIG. 5, the inspection vehicle is traveling in a left direction, and thus the imaging line 921 moves from the right side to the left side of the marker 904. The colors of the marker 904 are each constant in a left-right direction, and if the imaging can be performed while the imaging line 921 is within the width of the marker 904, marker detection is enabled.

In the monitoring system 1 according to one embodiment, an algorithm for detecting the marker can be implemented in hardware capable of parallel processing such as an FPGA (Field Programmable Gate Array). In this arrangement, the monitoring system 1 in one embodiment can rapidly perform image processing in real time.

### Embodiment

One embodiment according to the present invention is directed to the monitoring system for monitoring a structure such as a tunnel. The monitoring system is installed on a moving body such as an inspection vehicle that inspects the structure while traveling. The monitoring system periodically and continuously images predetermined positions of the structure, and performs control to start or stop the monitoring of the structure when the marker is detected in a captured image.

### <Overall Configuration of Monitoring System>

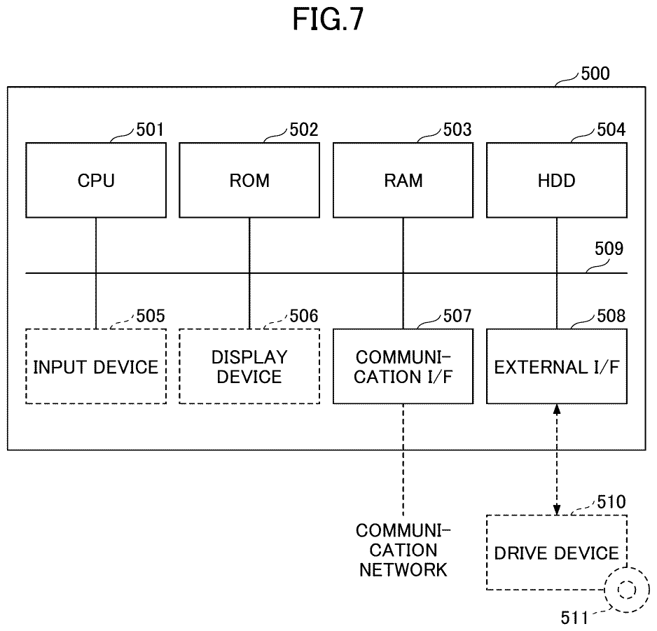

First, the overall configuration of the monitoring system according to the present embodiment will be described with reference to FIG. 6. FIG. 6 is a block diagram showing an example of the overall configuration of the monitoring system according to the present embodiment.

As shown in FIG. 6, the monitoring system 1 according to the present embodiment includes an imaging device 10, a marker detection device 20, and a measurement device 30. The imaging device 10 and the marker detection device 20 are electrically connected to each other, and the marker detection device 20 and the measurement device 30 are electrically connected to each other.

In the monitoring system 1, the imaging device 10, the marker detection device 20, and the measurement device 30 may be implemented as individual devices, or, a single monitoring device having functions to be provided by the imaging device 10, the marker detection device 20, and the measurement device 30 may be implemented.

The imaging device 10 is an electronic device that acquires one-dimensional image data (hereinafter also referred to as a “one-dimensional image”) capturing a predetermined position of the structure. One example of the imaging device 10 is a color line scan camera.

The marker detection device 20 is an information processing device such as a PC (personal computer), a workstation, or a server that detects a predetermined marker from the one-dimensional image acquired by the imaging device 10. The marker detection device 20 acquires the one-dimensional image from the imaging device 10, and detects a predetermined marker from the one-dimensional image. The marker detection device 20 transmits a control signal to instruct the measurement device 30 to start or stop the measurement based on a detection result for the marker.

The measurement device 30 is a device having: a measurement unit such as a laser distance sensor for measuring a state of the structure; and a storage that stores the measurement result, such as a PC (Personal Computer), a workstation, or a server. The measurement device 30 receives the control signal from the marker detection device 20, and starts or stops the measurement of the structure according to the control signal.

The overall configuration of the monitoring system 1 shown in FIG. 1 is an example, and various system configuration examples may be available depending on the use and purpose. For example, the marker detection device 20 may be mounted on a programmable processing circuit such as an FPGA (Field Programmable Gate Array) or an ASIC (Application Specific Integrated Circuit). The marker detection device 20 may be incorporated into the imaging device 10 or the measurement device 30.

### <Hardware Configuration of Monitoring System>

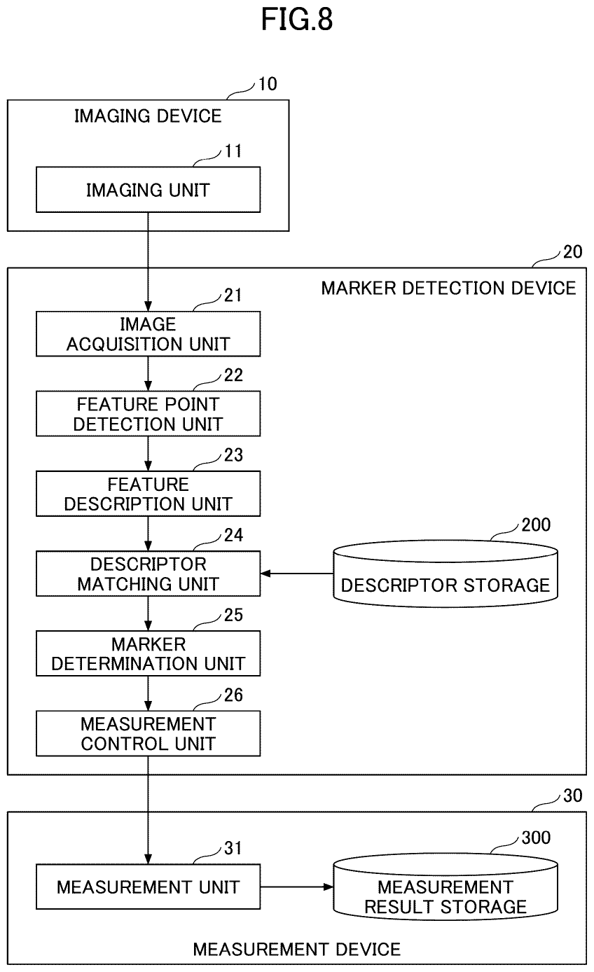

Hereinafter, a hardware configuration of the monitoring system 1 according to the present embodiment will be described with reference to FIG. 7.

### <<Hardware Configuration of Computer>>

The marker detection device 20 and the measurement device 30 according to the present embodiment are each implemented by, for example, a computer. FIG. 7 is a block diagram showing an example of the hardware configuration of a computer 500 according to the present embodiment.

As shown in FIG. 7, the computer 500 includes a CPU (Central Processing Unit) 501, a ROM (Read Only Memory) 502, a RAM (Random Access Memory) 503, an HDD (Hard Disk Drive) 504, an input device 505, a display device 506, a communication I/F (Interface) 507, and an external I/F 508. The CPU 501, the ROM 502, and the RAM 503 form what is known as a computer. Respective hardware components of the computer 500 are connected to one another via a bus line 509. The input device 505 and the display device 506 may be configured to be used by connecting these devices to the external I/F 508.

The CPU 501 is an arithmetic unit that reads programs and data from a storage device, such as the ROM 502 or the HDD 504, into the RAM 503. The CPU 501 then executes processing to thereby implement the control and functions of the entire computer 500.

The ROM 502 is an example of a nonvolatile semiconductor memory (storage device) that can retain programs and data even when the power is turned off. The ROM 502 functions as a main storage device that stores various programs, data and the like necessary for the CPU 501 to execute the various programs installed in the HDD 504. Specifically, the ROM 502 stores boot programs such as a BIOS (Basic Input/Output System) and an EFI (Extensible Firmware Interface) that are executed when the computer 500 is started, as well as data such as OS (Operating System) settings and network settings.

The RAM 503 is an example of a volatile semiconductor memory (storage device) that erases programs and data when the power is turned off. The RAM 503 includes, for example, a DRAM (Dynamic Random Access Memory), an SRAM (Static Random Access Memory), or the like. The RAM 503 provides a work area that is expanded when various programs installed in the HDD 504 are executed by the CPU 501.

The HDD 504 is an example of a nonvolatile storage device that stores programs and data. The programs and data stored in the HDD 504 include the OS that is basic software that controls the entire computer 500, as well as including applications and the like that provide various functions on the OS. Instead of the HDD 504, the computer 500 may use a storage device (e.g., SSD: Solid State Drive) that uses a flash memory as a storage medium.

The input device 505 includes a touch panel used by a user to input various signals; control keys and buttons; a keyboard; a mouse; and a microphone for inputting sound data such as voice.

The display device 506 includes a display such as a liquid crystal display of organic EL (Electro-Luminescence) that displays a screen, and includes a speaker or the like that outputs sound data such as voice.

The communication I/F 507 is an interface for connecting to a communication network and allowing the computer 500 to perform data communication.

The external I/F 508 is an interface with an external device. The external device includes a drive device 510 and the like.

The drive device 510 is a device for setting a recording medium 511. The recording medium 511 includes a medium for recording information optically, electrically, or magnetically, such as a CD-ROM, a flexible disk, or a magneto-optical disk. The recording medium 511 may also include a semiconductor memory for electrically recording information, such as a ROM or a flash memory. In this arrangement, the computer 500 can perform reading and/or writing of the recording medium 511 through the external I/F 508.

The various programs to be installed in the HDD 504 are installed, for example, when a distributed recording medium 511 is set in the drive device 510 that is connected to the external I/F 508, and then the various programs that are recorded in the recording medium 511 are read out by the drive device 510. Alternatively, the various programs to be installed in the HDD 504 may be installed by downloading the programs via the communication I/F 507 and another network, which is different from the communication network.

### <Functional Configuration of Monitoring System>

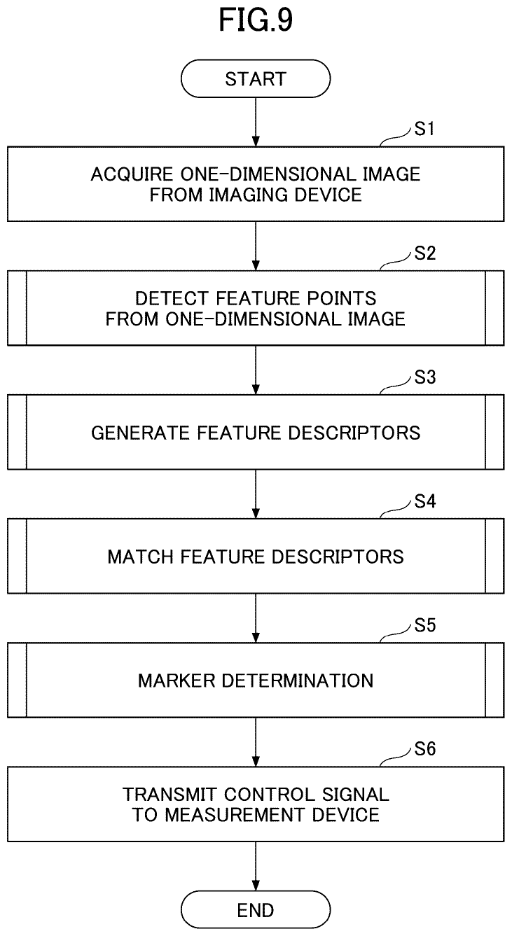

Hereinafter, a functional configuration of the monitoring system according to the present embodiment will be described with reference to FIG. 8. FIG. 8 is a block diagram showing an example of the functional configuration of the monitoring system 1 according to the present embodiment.

### <<Imaging Device>>

As shown in FIG. 8, the imaging device 10 according to the present embodiment includes an imaging unit 11.

The imaging unit 11 captures a predetermined position of a structure, and generates a one-dimensional image. The imaging unit 11 transmits the generated one-dimensional image to the marker detection device 20.

### <Marker Detection Device>

As shown in FIG. 8, the marker detection device 20 according to the present embodiment includes an image acquisition unit 21, a feature point detection unit 22, a feature description unit 23, a descriptor matching unit 24, a marker determination unit 25, a measurement control unit 26, and a descriptor storage 200.

The image acquisition unit 21, the feature point detection unit 22, the feature description unit 23, the descriptor matching unit 24, the marker determination unit 25, and the measurement control unit 26 are implemented by processing that a program expanded from the HDD 504 shown in FIG. 7 to the RAM 503 causes the CPU 501 to execute.

The descriptor storage 200 stores feature descriptors generated from one or more predetermined markers. A method of generating the feature descriptor will be described later. In the following, the feature descriptor stored in the descriptor storage 200 may be referred to as a “registered descriptor.” The descriptor storage 200 is implemented by the RAM 503 or the HDD 504 shown in FIG. 7.

The image acquisition unit 21 acquires a one-dimensional image from the imaging device 10. The image acquisition unit 21 may acquire the one-dimensional image in response to receiving the one-dimensional image transmitted from the imaging device 10, or may acquire the one-dimensional image by making a request for the one-dimensional image to the imaging device 10.

The feature point detection unit 22 detects one or more feature points from the one-dimensional image acquired by the image acquisition unit 21. The feature point detection unit 22 detects the feature points based on a SIFT (Scale-Invariant Feature Transform) algorithm. In the feature point detection according to the present embodiment, image data to be detected is one-dimensional, and a one-dimensional algorithm based on the SIFT is used.

The SIFT is one feature description method for finding features of various sizes in an image, and expressing the features by digitizing these features. The SIFT is used for object recognition or the like in the image. Details of the SIFT are disclosed in References 1 and 2 below.
[Reference 1] U.S. Pat. No. 6,711,293
[Reference 2] Lowe, David G, “Distinctive image features from scale-invariant keypoints,” International journal of computer vision, vol. 60.2, pp. 91-110, 2004.

The feature description unit 23 generates, for each feature point that is detected by the feature point detection unit 22, a feature descriptor representing a luminance change of a region including the feature point. The feature descriptor according to the present embodiment is a 24-dimensional vector representing a frequency of luminance changes for each primary color in sub-regions that are obtained by dividing the region centering on the feature point into a plurality of sub-regions. In the following, the feature descriptor that is generated from the one-dimensional image acquired by the image acquisition unit 21 may be referred to as an “observation descriptor.”

The descriptor matching unit 24 matches the observation descriptor generated by the feature description unit 23 with the registered descriptor stored in the descriptor storage 200. The descriptor matching unit 24 identifies a marker captured in the one-dimensional image based on the similarity between the observation descriptor and the registered descriptor. One example of a similarity measurement in the present embodiment is a Manhattan distance.

The marker determination unit 25 determines whether the marker is included in the one-dimensional image based on a pair (hereinafter may be referred to as a “descriptor pair”) of the observation descriptor and the registered descriptor as matched by the descriptor matching unit 24. The marker determination unit 25 calculates a center position of the marker for each feature point in the observation descriptor, and determines whether the marker is included in the one-dimensional image based on a histogram representing a frequency of the calculated center position.

The measurement control unit 26 transmits a control signal to instruct the measurement device 30 to start or stop measurement based on a determination result by the marker determination unit 25. The measurement control unit 26 transmits the control signal if the determination result indicates that the marker is included in the one-dimensional image. On the other hand, if the determination result indicates that the marker is not included in the one-dimensional image, the measurement control unit 26 does not transmit the control signal.

### <<Measurement Device>>

As shown in FIG. 8, the measurement device 30 in the present embodiment includes a measurement unit 31 and a measurement result storage 300.

The measurement unit 31 starts or stops the measurement for the structure according to the control signal that is received from the marker detection device 20. When the measurement unit 31 receives the control signal while not performing the measurement, the measurement unit 31 starts the measurement. On the other hand, if the measurement unit 31 receives the control signal while performing the measurement, the measurement unit 31 stops the measurement. The measurement unit 31 stores a measurement result that is obtained by performing the measurement, in the measurement result storage 300.

The measurement unit 31 is implemented by a measurement device, such as a laser distance sensor connected to the external I/F 508 shown in FIG. 7.

The measurement result storage 300 stores the measurement result obtained by the measurement unit 31. The measurement result storage 300 is implemented by the RAM 503 or the HDD 504 shown in FIG. 7.

### <Processing Procedure of Monitoring System>

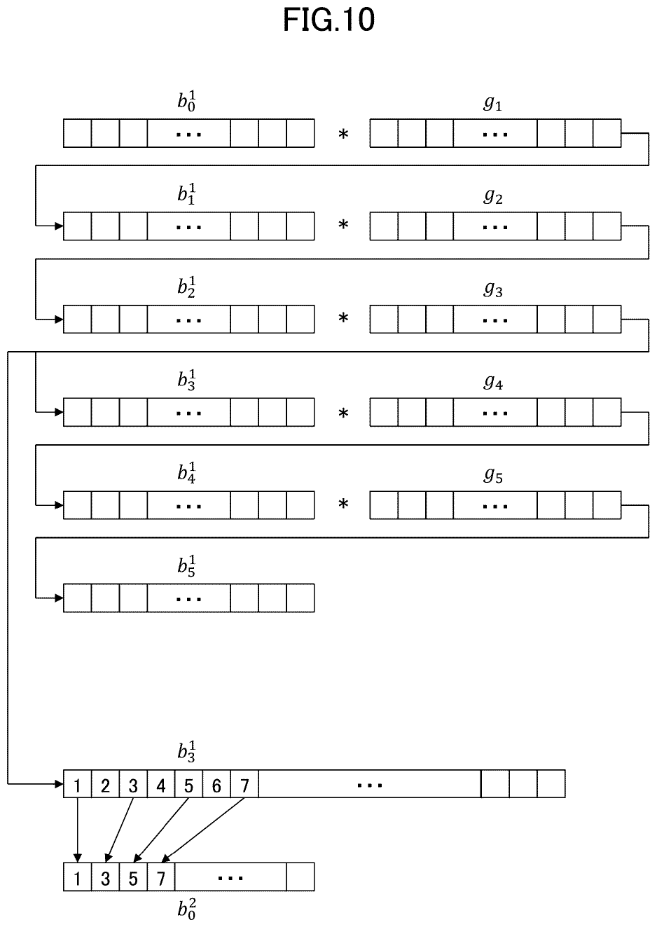

Hereinafter, a processing procedure of a monitoring method executed by the monitoring system 1 according to the present embodiment will be described with reference to FIGS. 9 to 21. FIG. 9 is a flowchart showing an example of the monitoring method according to the present embodiment.

In step S1, the imaging unit 11 of the imaging device 10 images a predetermined position of the structure and generates a one-dimensional image. The imaging unit 11 continuously repeats imaging at predetermined time intervals. An imaging interval may be determined according to a relative speed of the inspection vehicle and the structure, but the imaging interval is preferably as short as possible.

Next, the imaging unit 11 transmits the generated one-dimensional image to the marker detection device 20. The imaging unit 11 may transmit the one-dimensional image to the marker detection device 20 each time the imaging unit 11 generates the one-dimensional image, or the imaging unit 11 may transmit the latest one-dimensional image to the marker detection device 20 each time the image acquisition unit 21 receives a request to acquire a one-dimensional image from the marker detection device 20.

In the marker detection device 20, the image acquisition unit 21 receives the one-dimensional image from the imaging device 10. The image acquisition unit 21 transmits the received one-dimensional image to the feature point detection unit 22.

In step S2, the feature point detection unit 22 included in the marker detection device 20 receives the one-dimensional image from the image acquisition unit 21. Next, the feature point detector 22 detects feature point(s) from the received one-dimensional image. Next, the feature point detector 22 transmits feature point information indicating a given detected feature, to the feature description unit 23.

### <<Details of Feature Point Detection Process>>

The feature point is a center of a local peak or valley of luminance. It is known that an extremum σₑₓ of a normalized n-th derivative in a blurred image that is generated by folding Gaussian filters with a different standard deviation σ is proportional to the size of a feature in the image (see Reference 3).
[Reference 3] Lindeberg, Tony, “Feature detection with automatic scale selection.” International journal of computer vision, vol. 30, no. 2, pp. 79-116, 1998.

With use of the above characteristic, it is possible to detect the feature point (position x in the one-dimensional image representing a normalized second derivative extremum) and its magnitude (standard deviation σ) (hereinafter may be referred to as a “scale”). When image processing is actually performed, a difference between gradually blurred images is taken as an approximation of the normalized second derivative in order to omit the calculation of the second derivative.

A first stage of the feature point detection is the generation of one or more blurred images. Very small features are likely to be camera noise or the like, and thus initial blurring is performed on the image captured by the camera, such that the very small features are not detected. In the generation of the initial blurred image, a Gaussian filter with σ₀=1.6 is used. Reference 2 discloses that the best feature detection performance is obtained by using the Gaussian filter with σ₀=1.6.

As the scale σ increases, the Gaussian filter increases. In order to avoid heavy processing, after generating a differential image where an initial scale σ₀ is doubled, the image is downsampled by half to reuse the same Gaussian filter σ. In this arrangement, the process is equivalent to a case of convolving with a Gaussian filter of 2σ.

A set of images with the same number of blurred pixels that are obtained from the same sampled image is referred to as an “octave.” The number of octaves is equal to the number of times downsampling is performed plus one. The number of blurred images used in one octave is set to L=6. Steps of the scale σ are set as σ₀, kσ₀, k²σ₀, k³σ₀, k⁴σ₀, and k⁵σ₀ (k=2^{1/3}). Reference 2 discloses that the best feature point detection performance can be obtained by using the above parameters.

In the application of the traveling monitoring system, it is necessary to be able to detect a position marker regardless of distance. This is because a distance between the tunnel wall surface and the camera is not constant when the traveling monitoring system passes through multiple monitoring areas. After identifying the distance range between the marker and the camera, it is necessary to determine the number of octaves based on what scale of reduction or enlargement can be handled by the feature point detection to be performed, that is, to what extent the image is to be blurred.

When the above parameters are used, it is possible to detect features with a scale from kσ₀ to 2σ₀ in one octave. Assuming that features with scales varying from 1 to 2 times are used as markers, when a distance between the marker and the camera varies in the range where the marker is reduced from 1 to (≤1) times in a case where the marker is viewed with the camera, p, satisfying 2^{-p}≤a<2^{-p+1} (where p is a non-negative integer), is determined, and the number of octaves to be used is set as oₘₐₓ=p+2.

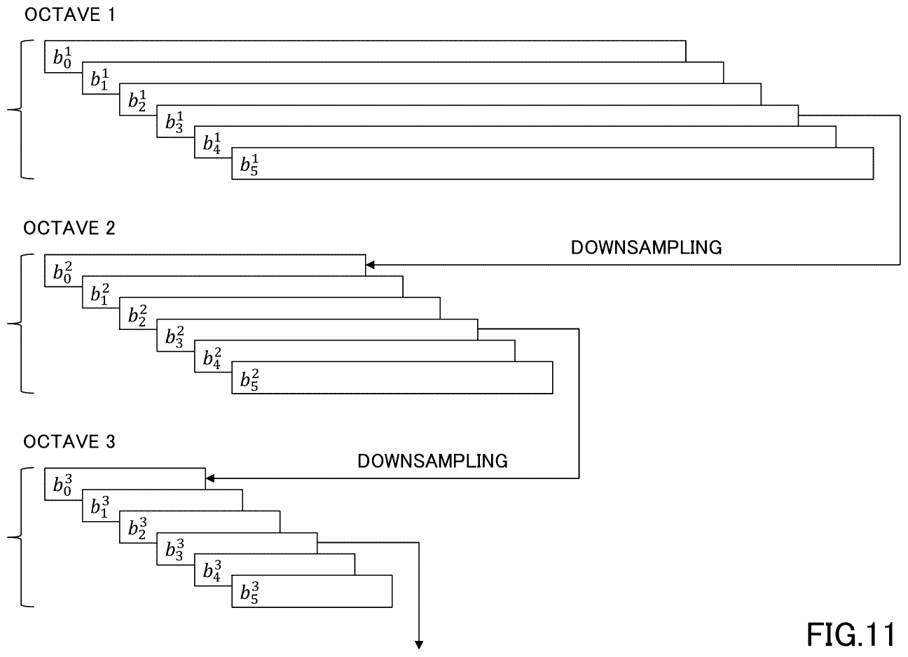

FIG. 10 is a conceptual diagram showing an example of a blurred image generation process. bₘ^{o} (o is an integer greater than or equal to 1 and less than or equal to oₘₐₓ, and m is an integer greater than or equal to zero and less than or equal to L−1) is a blurred image included in an octave o. Here, gₙ is a Gaussian filter obtained by quantizing a Gaussian function Gₙ for blurring the blurred image bₘ^{o}. The Gaussian function Gₙ is represented by Equations (1) and (2).

$$\begin{matrix}[ Math . 1 ] & \\ {G}_{n} = \frac{1}{\sqrt{2 π {σ}_{n}}} {e}^{- \frac{{x}^{2}}{2 {σ}_{n}^{2}}} & ( 1 )\end{matrix}$$

$${σ}_{n} = {k}^{n - 1} {σ}_{0} \sqrt{{k}^{2} - 1} ( 1 \leq n \leq 5 ) \qquad ( 2 )$$

As shown in FIG. 10, for example, a blurred image b₀¹ of Octave 1 is blurred by a Gaussian filter of, a blurred image b₁¹ is blurred by a Gaussian filter σ₂, and so on, such that generation of blurred images are repeated to generate blurred images b₀¹ to b₅¹ of Octave 1. At this time, a subsequent blurred image b0² of Octave 2 is generated by downsampling a blurred image b₃¹ by half. By repeating the process up to a maximum number of octaves oₘₐₓ, oₘₐₓ*L blurred images are generated.

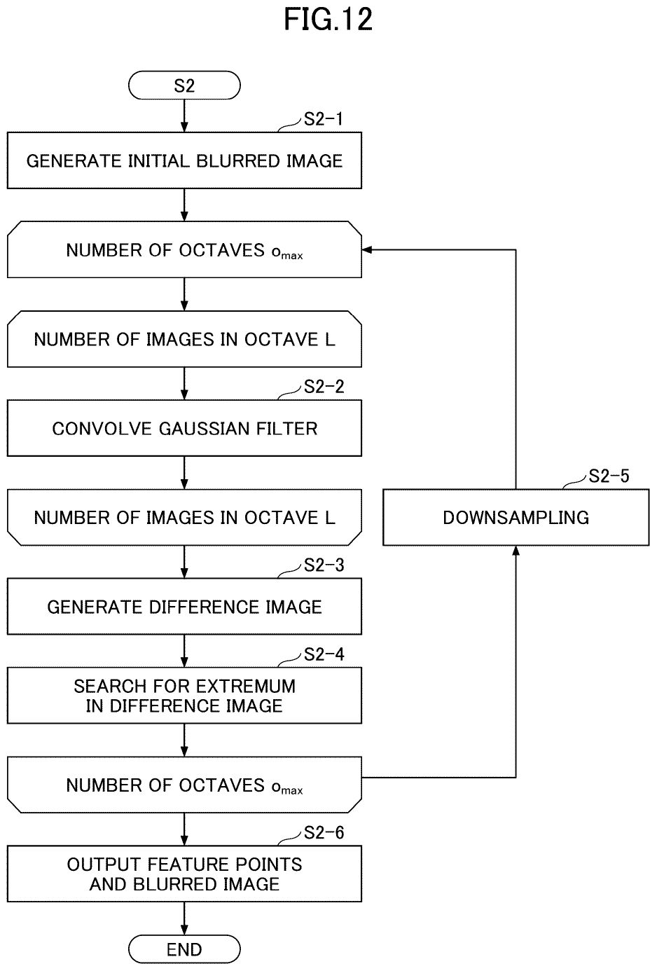

FIG. 11 is a conceptual diagram showing an example of the relationship between octaves. As shown in FIG. 11, each of Octaves 1 to 3 includes six blurred images b₀¹, . . . , b₅¹ to b₀³, . . . , b₅³. A blurred image bₘ² of Octave 2 is half the size of the blurred image bₘ¹ of Octave 1, and the blurred image bₘ³ of Octave 3 is half the size of the blurred image bₘ² of Octave 2.

The feature point detection is performed with pixels of a given primary color having the best spectral sensitivity and a good signal-to-noise ratio. Here, as an example, the feature point detection is performed with R pixels.

### (Procedure of Feature Point Detection Process)

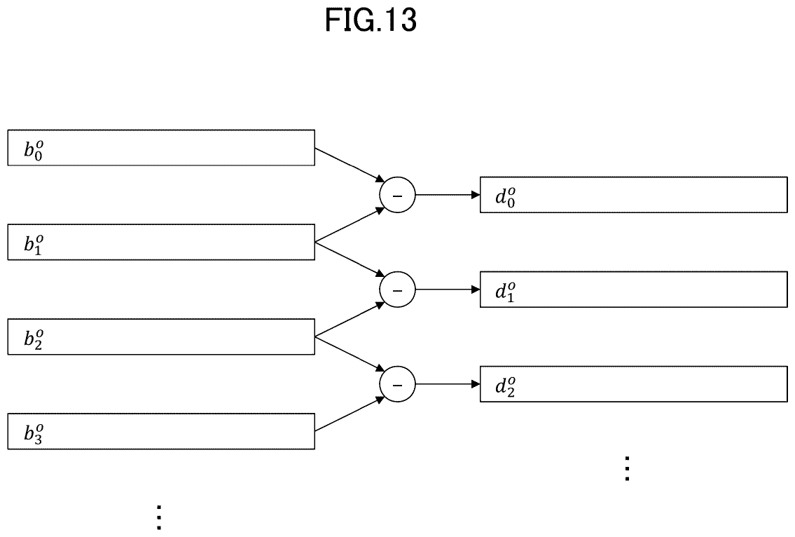

Hereinafter, a feature point detection process (step S2 in FIG. 9) in the present embodiment will be described in detail with reference to FIG. 12. FIG. 12 is a flowchart showing an example of the feature point detection process in the present embodiment.

In step S2-1, the feature point detection unit 22 generates an initial blurred image b₀¹ by convolving the Gaussian filter σ₀ with the one-dimensional image received from the image acquisition unit 21.

In step S2-2, the feature point detection unit 22 generates the Gaussian filter gₙ and convolves the Gaussian filter gₙ with the blurred image bₘ^{o}. As a result, a blurred image bₘ₊₁^{o} is generated by blurring the blurred image bₘ^{o}.

The feature point detection unit 22 repeats step S2-2 L−1 times. That is, step S2-2 is repeated until the number of blurred images in the octave reaches L, expressing the number of burred images. As a result, an octave o including L blurred images, b₀^{o} to b_{L-1}^{o}, is generated.

A product of Gaussian functions is equivalent to a Gaussian function with a variance that is equal to the sum of respective individual variances. Using this characteristic, a blurring process is repeated in a cascading manner as described above to generate a plurality of blurred images that are obtained by gradually blurring the one-dimensional image. With this approach, computational complexity of generating blurred images can be reduced.

In step S2-3, the feature point detector 22 calculates a difference in per-pixel luminance between adjacent blurred images bₙ^{o} and bₙ₊₁^{o}. As a result, a difference image dₙ^{o} is generated. When a luminance value of a pixel x in the difference image dₙ^{o} for an octave o and a scale n is expressed as dₙ^{o}(x), dₙ^{o}(x)=bₙ^{o}(x)−bₙ₊₁^{o}(x) is satisfied. The number of difference images dₙ^{o} generated in such a manner becomes L−1.

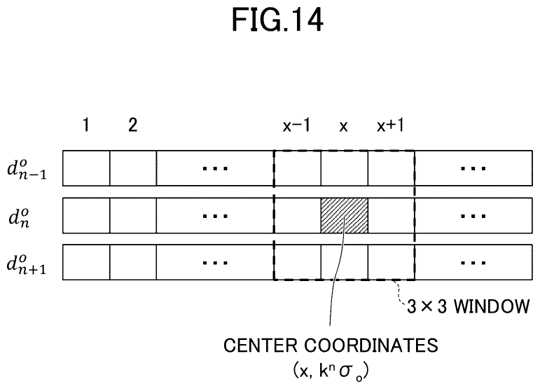

FIG. 13 is a conceptual diagram showing a specific example of a difference image generation process. As shown in FIG. 13, the difference image d₀^{o} is generated by calculating a difference in per-pixel luminance between blurred images b₀^{o} and b₁^{o}. Similarly, a difference image d₁^{o} is generated by calculating a difference in per-pixel luminance between blurred images b₁^{o} and b₂^{o}, and a difference image d₂^{o} is generated by calculating a difference in per-pixel luminance between blurred images b₂^{o} and b₃^{o}.

Referring back to FIG. 12, the description will be provided as follows. In step S2-4, the feature point detector 22 searches for an extremum in the difference image dₙ^{o}. The feature point detector 22 stores a detected extremum as the feature point.

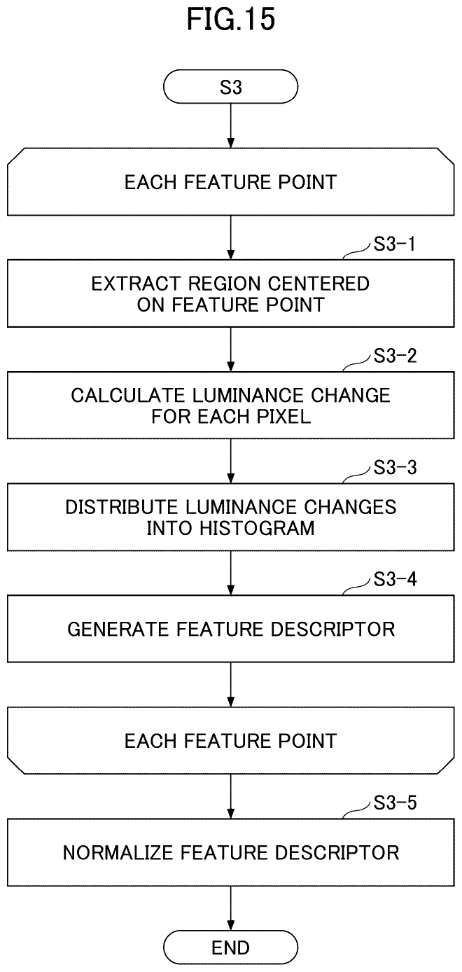

FIG. 14 is a conceptual diagram showing a specific example of an extremum search process. As shown in FIG. 14, in the extremum search process, first, three adjacent difference images dₙ₋₁^{o}, dₙ^{o}, and dₙ₊₁^{o} are combined as luminance data having two variables (x, σ). Next, pixels of a 3×3 window are extracted. Next, it is determined whether the luminance of a center pixel of the extracted window is at a maximum or minimum in the window. If the luminance of the center pixel is at the maximum or minimum, the center pixel is set as a feature point, and the variables (x, σ) for the feature point is stored.

The feature point detector 22 performs the above extremum detection for all center pixels that can be extracted from the 3×3 window. As a result, L−3 values are acquired as the scale σ of the feature point.

Referring back to FIG. 12, the description will be provided as follows. In steps S2-5, the feature point detector 22 downsamples the blurred image b_{L-3}^{o} included in the octave o. As a result, a blurred image b₀^{o+1} included in a subsequent octave o+1 is generated. Thereafter, the feature point detector 22 returns the process to step S2-2, and executes steps S2-2 to S2-4 again for the octave o+1.

The feature point detector 22 repeats steps S2-2 to S2-5 oₘₐₓ times. That is, the feature point detector 22 repeats steps S2-2 to S2-5 up to a maximum number of octaves.

In step S2-6, the feature point detector 22 outputs detected feature points (x, σ) and the initial blurred image b₀¹.

Referring back to FIG. 9, the description will be provided as follows. In step S3, the feature description unit 23 included in the marker detection device 20 receives feature point information from the feature point detector 22. Next, for each feature point that is represented in the feature point information, the feature description unit 23 generates an observation descriptor representing a luminance change of a region including the feature point. Next, the feature description unit 23 transmits the generated observation descriptor to the descriptor matching unit 24.

### <<Details of Feature Descriptor Generation Process>>

The feature descriptor is data representing luminance changes between pixels in the vicinity of the feature point. Even if a color or intensity of ambient light changes for each monitoring area of a given structure, the relative luminance changes between pixels are unchanging. Marker detection can be performed stably by using the luminance changes, instead of the luminance values themselves.

In generating the feature descriptor, values representing luminance changes are distributed into a histogram, for four sub-regions that are obtained by dividing the pixel region having a length of 60 and including the feature point into four parts. By using the histogram, the effect of rotation (i.e. if the marker is not at a right angle with respect to a viewing angle of the camera) with respect to a direction perpendicular to a marker plane can be alleviated. Even if one or more positions of pixels in the vicinity of the feature point change slightly due to rotation, nearly identical feature descriptors can be generated because the feature descriptor is insensitive to positional changes.

By using a given pixel region proportional to the scale of the feature, the same feature descriptor can be generated for the same feature even if the same feature is captured under conditions with different distances (that is, even if the scale changes). In this arrangement, different features can be expressed with respective unique feature descriptors.

The feature descriptor classifies luminance changes into binary values of positive or negative in four sub-regions, and calculates values for the luminance of each of the RGB components. In this arrangement, a feature descriptor with 24 values (i.e., a 24-dimensional vector) is generated for one feature point.

Finally, all generated feature descriptors are adjusted to have the same length such that comparison of feature descriptors is facilitated. The selection of the distance metric that is used to represent length affects detection accuracy and computational complexity. In the present embodiment, the Manhattan distance is used as the distance metric. Although a Euclidean distance is often used as the distance metric between vectors, the Manhattan distance omits the calculation of squares and square roots, and as a result, the computational complexity can be reduced. In addition, experiments have shown that there is no difference in detection accuracy as compared to the Euclidean distance.

The Euclidean distance between point P=(p₁, p₂, . . . , pₙ) and point Q=(q₁, q₂, . . . , qₙ) in an n-dimensional space is expressed by Equation (3). The Manhattan distance is expressed by Equation (4). The Manhattan distance can be said to be a distance where a direction of movement is restricted along an axial direction of each dimension.

$$\begin{matrix}[ Math . 2 ] & \\ L = \sqrt{{\sum }_{i = 1}^{n} {( {p}_{i} - {q}_{i} )}^{2}} & ( 3 )\end{matrix}$$

$$L = {\sum }_{i = 1}^{n} \vert {p}_{i} - {q}_{i} \vert \qquad ( 4 )$$

### (Procedure of Feature Descriptor Generation Process)

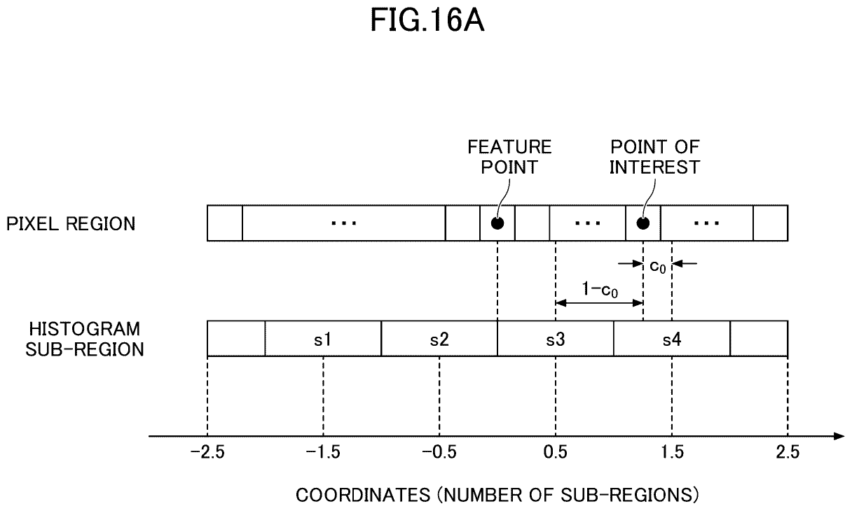

Hereinafter, a feature descriptor generation process (step S3 in FIG. 9) in the present embodiment will be described in detail with reference to FIG. 15. FIG. 15 is a flowchart showing an example of the feature descriptor generation process in the present embodiment.

In step S3-1, the feature description unit 23 extracts a pixel region corresponding to five sub-regions (7.5σ) where the feature point is located in a center. If 3.75σ is not an integer, a pixel region twice the size of a value that is rounded down to the nearest integer is extracted.

In step S3-2, the feature description unit 23 calculates a luminance change Δbₙ^{o}(x)=bₙ^{o} (x+1)−bₙ^{o}(x−1) for each pixel in the extracted pixel region.

In step S3-3, the feature description unit 23 distributes the calculated luminance change Δbₙ^{o}(x) into the histogram. At this time, the feature description unit 23 distributes a luminance change value of the pixel based on a position of the pixel with respect to a bin center of the histogram. In this arrangement, the distribution into the histogram becomes smooth.

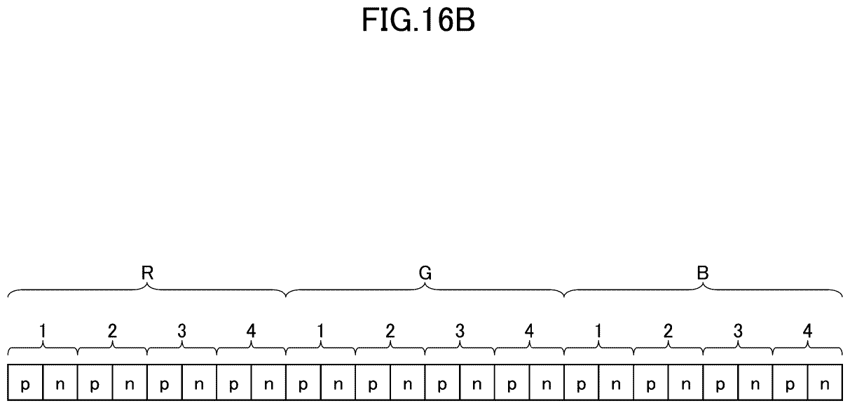

FIG. 16A is a diagram for describing the distribution into the histogram. As shown in FIG. 16A, in the distribution to the histogram, coordinates from −2.5 to 2.5 are considered in units of sub-regions, by setting the position of the feature point as 0. Respective center coordinates of bins, corresponding to sub-regions s1 to s4, are −1.5, −0.5, 0.5, and 1.5. Here, the bin for distribution is selected based on whether the luminance change of a pixel of interest is positive or negative (if positive, the bin is assigned to p, and if negative, the bin is assigned to n).

The luminance change of pixel(s) located within a distance of 1.0 from the bin center of each of the sub-regions s1 to s4 is multiplied by a distance coefficient, and the resulting value is distributed into the bin. For the pixel of interest shown in FIG. 16A, a distance from the center of the sub-region (s4) nearest to an upper side is defined as c₀. Δb*c₀, obtained by multiplying the luminance change Δb of the pixel of interest by c₀, is added to a histogram value of the sub-region (s3) nearest to a lower side, and Δb*(1−c₀), obtained by multiplying the luminance change Δb by (1−c₀), is added to a histogram value of the sub-region (s4) nearest to the upper side.

Referring back to FIG. 15, the description will be provided as follows. In step S3-4, the feature description unit 23 generates a feature descriptor based on the histogram into which the luminance changes are distributed.

FIG. 16B is a diagram for describing the feature descriptor. As shown in FIG. 16B, the feature descriptor is represented by the 24-dimensional vector that has the positive bin p and the negative pin n for each of the sub-regions s1 to s4, for each of the RGB components.

For example, if the luminance change of the point of interest shown in FIG. 16A is positive, Δb*c₀ is added to a bin R3p. On the other hand, if the luminance change is negative, Δb*(1−c₀) is added to a bin R4p.

The feature description unit 23 repeatedly executes steps S3-1 to S3-4 for each feature point that is detected in the feature point detection process. In this arrangement, feature descriptors are generated for respective feature points.

Referring back to FIG. 15, the description will be provided as follows. In step S3-5, the feature description unit 23 normalizes the generated feature descriptors. The feature description unit 23 first calculates the Manhattan distance between the feature descriptors and an origin. Next, the feature description unit 23 divides an element of each feature descriptor by a calculated distance. In this arrangement, the feature descriptor that is normalized to a distance 1 from the origin is generated.

Referring back to FIG. 9, the description will be provided as follows. In step S4, the descriptor matching unit 24 included in the marker detection device 20 receives the observation descriptor from the feature description unit 23. Next, the descriptor matching unit 24 reads the registered descriptor from the descriptor storage 200. Subsequently, the descriptor matching unit 24 matches the received observation descriptor with the read registered descriptor. Then, the descriptor matching unit 24 transmits a matched descriptor pair to the marker determination unit 25.

### <<Feature Descriptor Matching Process>>

In a feature descriptor matching process, the registered descriptor that is generated in advance from a marker to be detected is matched with the observation descriptor generated in the feature descriptor generation process. Whether the registered descriptor and the observation descriptor are identical is determined based on the Manhattan distance between feature descriptors. The closer the distance between the feature descriptors is, the closer the values of elements of the vectors are as a whole, and there is a high possibility that the feature descriptors represent identical features.

In an image captured during travel, there may be a variation in the difference between values of vectors due to noise and vibration of the camera. In this case, it is difficult to set a fixed threshold for the Manhattan distance. By using a ratio of a distance between a descriptor with the closest Manhattan distance (hereinafter referred to as a “first neighboring point”) and a descriptor with the next closest Manhattan distance (hereinafter referred to as a “second neighboring point”), highly accurate matching is realized.

Ideally, one feature has a unique feature descriptor. In this case, if the influence of noise or the like is small, the observation descriptor and registered descriptor, corresponding to a feature included in the image with the marker, are substantially identical.

In a case of an image with a captured marker, a distance to the first neighboring point approaches 0 because the distance is between identical feature descriptors. In addition, a distance to the second neighboring point is relatively large because the distance is between unrelated feature descriptors. As a result, a distance ratio derived from the first neighboring point and the second neighboring point approaches 0. On the other hand, in a case of an image without a captured marker, a distance ratio derived from the first neighboring point and the second neighboring point approaches 1 because the first neighboring point and the second neighboring point involve unrelated feature descriptors.

With use of the above characteristic, it is determined that the observation descriptor and the registered descriptor are identical feature descriptors when the distance ratio derived from the first neighboring point and the second neighboring point is less than a predetermined threshold t_{R}. Although the threshold t_{R} may be arbitrarily determined, it may be determined, for example, to be a threshold that ensures an accuracy rate of 90% or higher and that minimizes an error rate, when an experiment is performed using a marker to be used.

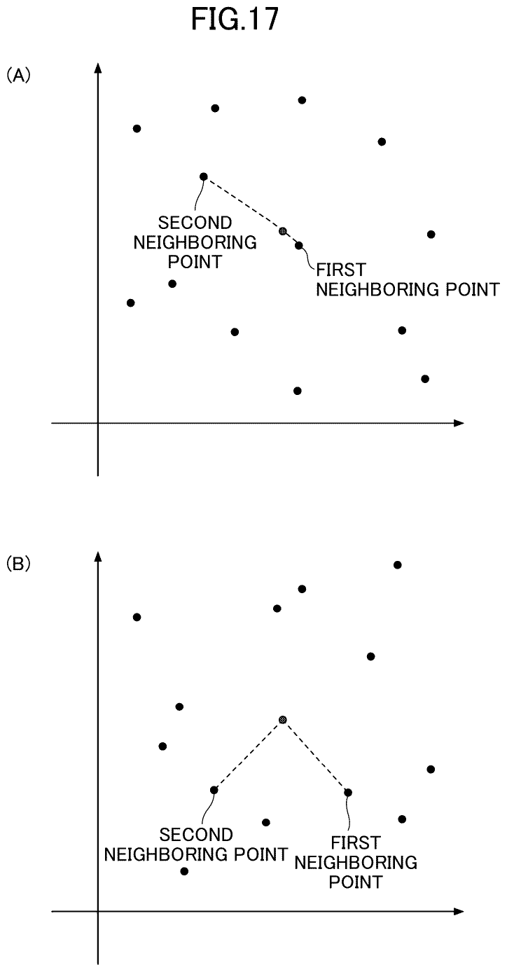

FIG. 17 is a diagram showing specific examples of the distance ratio derived from neighboring points. FIG. 17(A) is a diagram showing the relationship between the first neighboring point and the second neighboring point in an image with a captured marker. FIG. 17(B) is a diagram showing the relationship between the first neighboring point and the second neighboring point in an image without a captured marker.

As shown in FIG. 17(A), in the image with the captured marker, the distance to the first neighboring point is close, while the distance to the second neighboring point becomes far. In this case, a distance ratio derived from the first neighboring point and the second neighboring point approaches 0 and becomes small. As shown in FIG. 17(B), in the image without the captured marker, both the distance to the first neighboring point and the distance to the second neighboring point become far. In this case, a distance ratio derived from the first neighboring point and the second neighboring point approaches 1 and becomes large.

### (Procedure of Feature Descriptor Matching Process)

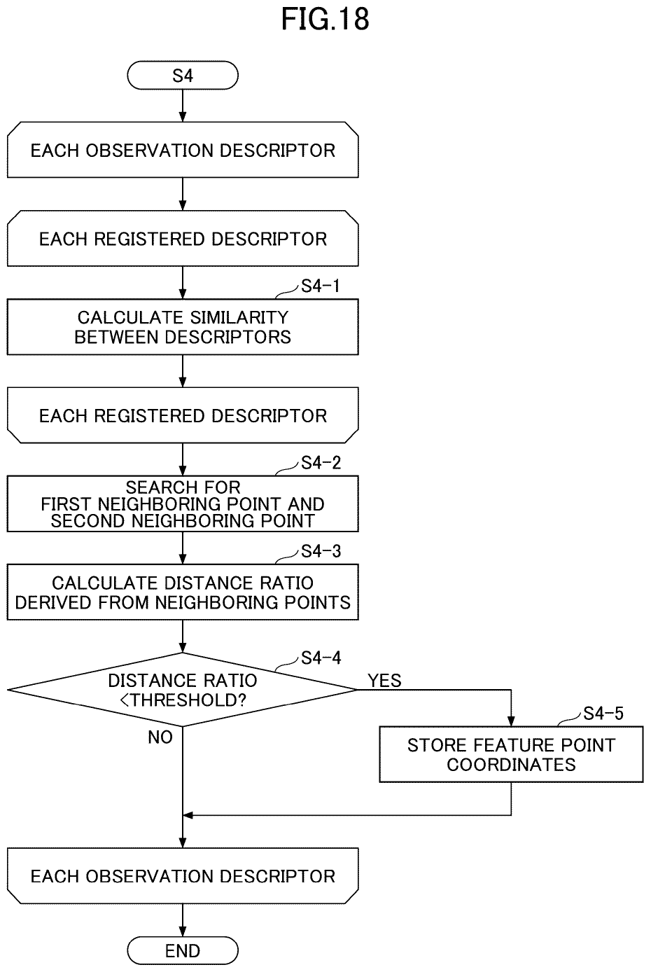

Hereinafter, a feature descriptor matching process (step S4 in FIG. 9) in the present embodiment will be described in detail with reference to FIG. 18. FIG. 18 is a flowchart showing an example of the feature descriptor matching process in the present embodiment.

In step S4-1, the descriptor matching unit 24 calculates the Manhattan distance between points, while setting the observation descriptor and the registered descriptor as the points in a 24-dimensional space.

The descriptor matching unit 24 executes step S4-1 for all registered descriptors stored in the descriptor storage 200. As a result, the Manhattan distance to the observation descriptor is calculated for all registered descriptors.

In step S4-2, the descriptor matching unit 24 searches for the first neighboring point and the second neighboring point based on the calculated Manhattan distance. The descriptor matching unit 24 first arranges Manhattan distances, corresponding to respective registered descriptors, in ascending order. Next, the descriptor matching unit 24 sets the registered descriptor having the smallest Manhattan distance as the first neighboring point. The descriptor matching unit 24 sets the registered descriptor having the second smallest Manhattan distance as the second neighboring point.

In step S4-3, the descriptor matching unit 24 calculates the distance ratio, derived from the first nearest neighbor point and the second nearest neighbor point. That is, the descriptor matching unit 24 divides the Manhattan distance to the first neighboring point by the Manhattan distance to the second neighboring point.

In step S4-4, the descriptor matching unit 24 determines whether the calculated distance ratio is less than the threshold t_{R}. If the distance ratio is less than the threshold t_{R} (YES), the descriptor matching unit 24 proceeds to step S4-5. On the other hand, if the distance ratio is greater than or equal to the threshold t_{R} (NO), the descriptor matching unit 24 skips step S4-5.

In step S4-5, the descriptor matching unit 24 stores the coordinates (x_{DB}/σ_{DB}) of the feature point of the first neighboring point in association with the coordinates (x_{T}, σ_{T}) of the feature point of the observation descriptor.

The descriptor matching unit 24 repeatedly executes steps S4-1 to S4-5 for each observation descriptor. As a result, a descriptor pair that is a pair of an observation descriptor and a registered descriptor, representing identical features, is generated.

Referring back to FIG. 9, the description will be provided as follows. In step S5, the marker determination unit 25 included in the marker detection device 20 receives the descriptor pair from the descriptor matching unit 24. Next, the marker determination unit 25 determines whether the marker is included in the one-dimensional image based on the received descriptor pair. Subsequently, the marker determination unit 25 transmits a determination result to the measurement control unit 26.

### <<Marker Determination Process>>

A positional relationship between feature points of the marker is maintained even if the position of the marker changes. By using this characteristic, a center position of the marker is estimated for each matched descriptor pair, and when the variation in the position distribution is small (in other words, estimated center positions converge to approximately one location), an object is determined as the marker.

The center position of the marker is obtained by adding, to a position x_{T} of the feature point of the camera image, a value obtained by scaling a distance from a center of the characteristic points of the image (hereinafter also referred to as a “marker image”) with the captured marker as a detection target, with a scaling factor, σ_{T}/σ_{DB}, of characteristic points of the image (hereinafter also referred to as a “camera image”) of a captured structure.

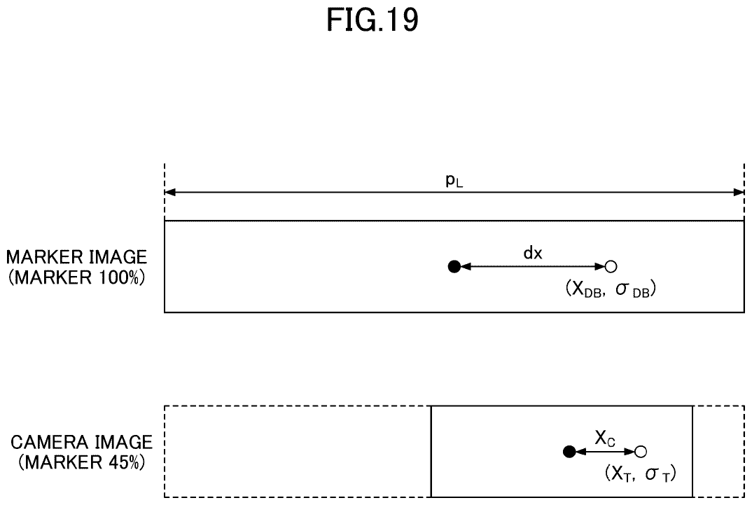

FIG. 19 is a diagram showing a specific example of a center position estimation process. As shown in FIG. 19, for the marker image, it is assumed that the marker is captured in 100% of p_{L} pixels. For the camera image, it is assumed that the marker is captured in 45% of p_{L} pixels.

If the scale and matching of feature points are perfectly accurate, feature point pairs corresponding to all markers would indicate a single center position. However, the scale of the feature points is discrete, and adjacent scales differ by a factor of k. Therefore, there is a possibility that the indicated scale may deviate from a true scale by a maximum factor of k^{±0.5}σ.

When estimating the center position of the marker, a maximum possible deviation of the estimated position is δx_{c}=p_{L}/2 (k^{1/2}−k^{-1/2}) for the feature point at the farthest edge of the marker image (dx=p_{L}/2).

A bin width of the histogram dividing pixel positions 1 to p_{L} is δx_{c}/3. A value to be used for marker determination is the sum of counts in a bin with a maximum count and its adjacent bins on both sides, including all counts within the range of the maximum possible deviation in the estimated position. This is because when the estimated center position is located at an end of the bin, the count may be dispersed into two bins.

When the sum of the counts is equal to or greater than a predetermined threshold t_{H}, it is determined that a given marker is captured in the camera image. Although the threshold t_{H} may be arbitrarily determined, it may be assumed, for example, that a balance between required sensitivity and a false positive rate is provided by experimenting with actual noise conditions.

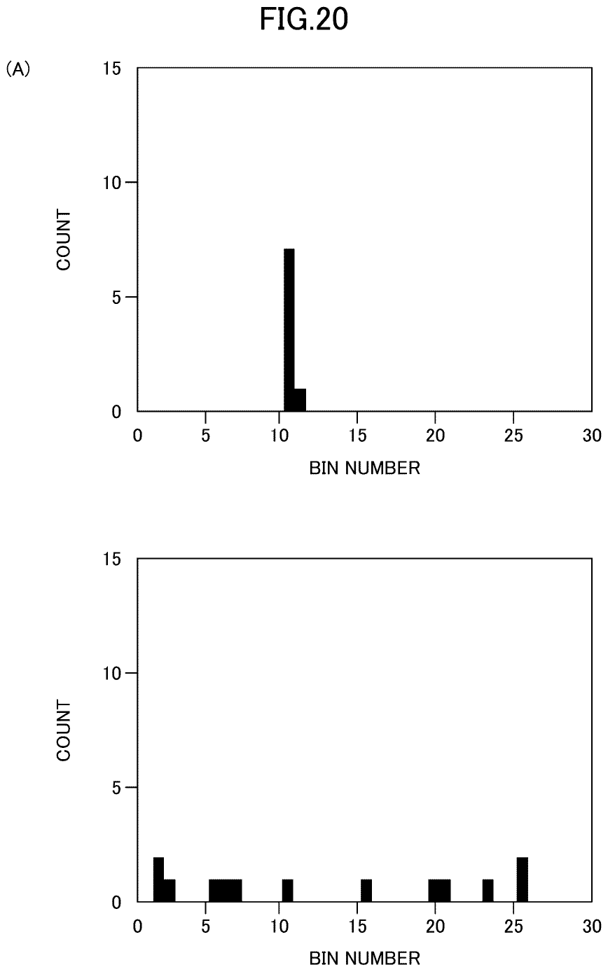

FIG. 20 is a diagram showing a specific example of a center position estimation result. FIG. 20(A) is a diagram showing the center position estimation result in an image with the captured marker. FIG. 20(B) is a diagram showing the center position estimation result in an image without the captured marker.

As shown in FIG. 20(A), in the image with the captured marker, estimated center positions are concentrated in approximately one bin. As shown in FIG. 20(B), in the image without the captured marker, the estimated center positions are dispersed over a wide range. Further, as shown in FIG. 20(A), even in the image with the captured marker, the estimated center positions may be counted in adjacent bins.

### (Procedure of Marker Determination Process)

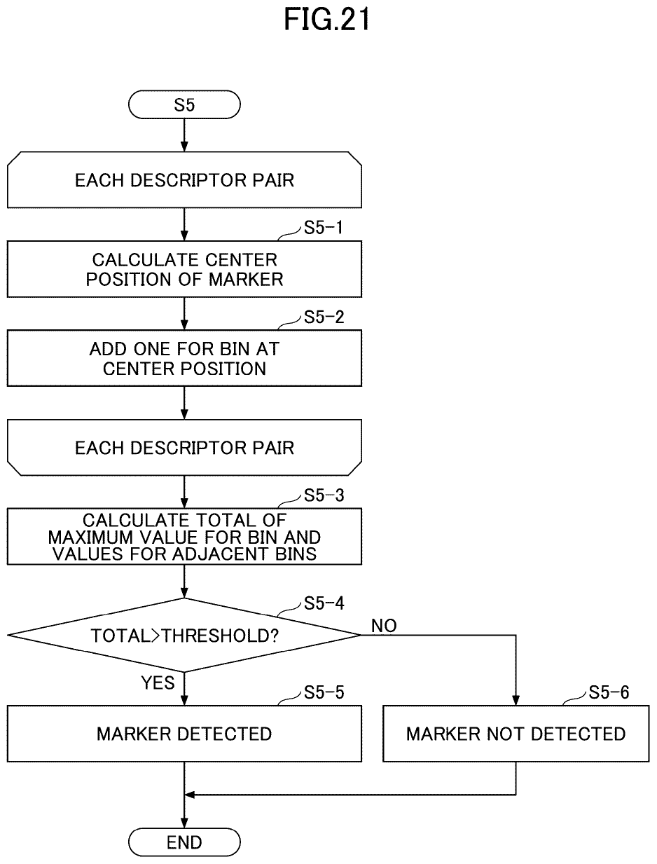

Hereinafter, a marker determination process (step S5 in FIG. 9) in the present embodiment will be described in detail with reference to FIG. 21. FIG. 21 is a flowchart showing an example of the marker determination process in the present embodiment.

In step S5-1, the marker determination unit 25 estimates the center position of the marker for the coordinates included in the descriptor pair. The center position is estimated by calculating Equations (5) to (7).

$$\begin{matrix}[ Math . 3 ] & \\ dx = \frac{{p}_{L}}{2} - {x}_{DB} & ( 5 )\end{matrix}$$

$${r}_{σ} = \frac{{σ}_{T}}{{σ}_{DB}} \qquad ( 6 )$$

$${x}_{C} = {x}_{T} + {r}_{σ} dx \qquad ( 7 )$$

In step S5-2, the marker determination unit 25 adds +1 to the count of a given bin corresponding to the estimated center position. If the estimated center position falls outside the range of greater than or equal to 1 and less than or equal to p_{L} (that is, outside the range of pixel positions in the camera image), no action is taken.

The marker determination unit 25 repeatedly executes steps S5-1 and S5-2 for each descriptor pair as matched by the feature descriptor matching process. In this arrangement, the center position is estimated for each descriptor pair.

In step S5-3, the marker determination unit 25 calculates the sum of the count in the bin with the maximum value in the histogram and the counts in its adjacent bins.

In step S5-4, the marker determination unit 25 determines whether the calculated sum of counts is equal to or greater than a threshold ta. If the sum of the counts is equal to or greater than the threshold TH (YES), the marker determination unit 25 advances the process to step S5-5. On the other hand, if the sum of the counts is less than the threshold ta (NO), the marker determination unit 25 advances the process to step S5-6.

In step S5-5, the marker determination unit 25 outputs a determination result indicating that the marker has been detected.

In step S5-6, the marker determination unit 25 outputs a determination result indicating that the marker has not been detected.

Referring back to FIG. 9, a description will be provided as follows. In step S6, the measurement control unit 26 of the marker detection device 20 receives the determination result from the marker determination unit 25. Next, the measurement control unit 26 transmits a control signal to the measurement device 30 when the received determination result indicates that the marker has been detected. On the other hand, the measurement control unit 26 does not transmit the control signal when the determination result indicates that the marker has not been detected.

In the measurement device 30, the measurement unit 31 receives the control signal from the marker detection device 20. When the measurement unit 31 receives the control signal while not performing measurement, the measurement unit 31 starts the measurement. When the measurement unit 31 receives the control signal while performing measurement, the measurement unit 31 stops the measurement.

Then, the measurement unit 31 stores a measurement result obtained by performing the measurement, in the measurement result storage 300. The measurement result includes measurement time(s), measurement position(s), measurement value(s), and the like. The measurement position can be acquired based on the marker detected by the marker detection device 20. Identification information indicating a marker may be included in the measurement result, instead of the measurement value.

### Effects of Embodiments

The marker determination device in the present embodiment detects feature points from a one-dimensional image of a captured marker in which a plurality of colors are arranged along one direction, and then determines whether the marker is included in the one-dimensional image based on a matching result with a correct feature descriptor. The computational complexity can be greatly reduced by performing marker detection based on the one-dimensional image. In this arrangement, according to the marker determination device in the present embodiment, the marker can be detected at high speed.

In particular, the marker determination device in the present embodiment performs two-stage matching that includes performing matching based on the similarity of feature descriptors; and determination based on the positional relationship of feature points in the feature descriptors. In this arrangement, the marker determination device in the present embodiment can perform stable marker detection with an extremely low false detection rate.

In addition, the marker determination device according to the present embodiment reduces the computational complexity by reducing, to one dimension, a conventional SIFT algorithm, which is stable but has a large computational complexity. Furthermore, by matching the feature descriptor with the Manhattan distance, it becomes possible to implement the marker determination device in an FPGA, which achieves a further increase in speed. In this arrangement, the marker determination device according to the present embodiment can perform marker detection at high speed even from a moving vehicle.

With this arrangement, in the marker determination device according to the present embodiment, the accuracy of marker detection improves, and consistency in a monitoring object is obtained. As a result, by using the marker determination device according to the present embodiment, the traveling monitoring system with high accuracy and high speed can be implemented.

The monitoring system according to the present embodiment reduces the time required for position marking and measurement setup in a conventional manual inspection. As a result, in the monitoring system according to the present embodiment, monitoring can be performed during operation, and the inspection efficiency is greatly improved.

### [Supplement]

Each of the functions of the above-described embodiments can be implemented by one or more processing circuits. Here, the term “processing circuit” as used herein includes: a processor programmed to execute each function by software, such as a processor implemented by an electronic circuit; or a device such as an ASIC (Application Specific Integrated Circuit), a DSP (Digital Signal Processor), an FPGA (Field Programmable Gate Array), or a conventional circuit module, where the device is designed to implement each of the above-described functions.

Although the above-described embodiments of the present invention have been described in detail, the present invention is not limited to these embodiments, and various modifications and changes can be made within the scope of the gist of the invention set forth in the claims.

This application claims the priority of Japanese Patent Application No. 2022-81497, filed on May 18, 2022 with the Japan Patent Office, the contents of which are incorporated herein by reference in its entirety.

### DESCRIPTION OF SYMBOLS

1 monitoring system
10 imaging device
11 imaging unit
20 marker detection device
21 image acquisition unit
22 feature point detection unit
23 feature description unit
24 descriptor matching unit
25 marker determination unit
26 measurement control unit
200 descriptor storage
30 measurement device
31 measurement unit
300 measurement result storage

1. A marker detection device comprising:
a memory configured to store, as a registered descriptor, a feature descriptor generated from an image in which a marker is captured, the marker including a plurality of colors arranged in one direction; and
circuitry configured to
acquire a one-dimensional image;
detect a feature point from the one-dimensional image;
generate, as an observation descriptor, the feature descriptor that represents a luminance change of a region including the feature point; and
determine whether the marker is included in the one-dimensional image, based on a matching result between the registered descriptor and the observation descriptor.

2. The marker detection device according to claim 1, wherein the circuitry is configured to detect the feature point by a SIFT algorithm.

3. The marker detection device according to claim 2,
wherein the circuitry is configured to match the registered descriptor with the observation descriptor, based on a Manhattan distance between the registered descriptor and the observation descriptor.

4. The marker detection device according to claim 1, wherein the feature descriptor represents a frequency of luminance change for each primary color in sub-regions that are obtained by dividing a region centered on the feature point into multiple parts.

5. The marker detection device according to claim 3, wherein the circuitry is configured to determine whether the marker is included in the one-dimensional image, based on a positional relationship of feature points between a pair of the registered descriptor and the observation descriptor that are matched.

6. The marker detection device according to claim 5, wherein the circuitry is configured to determine whether the marker is included in the one-dimensional image, based on a frequency of a center position of the marker that is calculated for each feature point.

7. A monitoring system, configured to be installed on a moving object, for measuring a state of a structure on which a marker is provided, the marker including a plurality of colors arranged in a direction perpendicular to a moving direction of the moving object, and the monitoring system comprising:
an imaging device configured to capture a one-dimensional image including a predetermined position of the structure;
a marker detection device configured to detect the marker from the one-dimensional image; and
a measurement device configured to measure the state of the structure,
wherein the marker detection device includes:
a memory configured to store, as a registered descriptor, a feature descriptor generated from the image in which the marker is captured; and
circuitry configured to
detect a feature point from the one-dimensional image;
generate, as an observation descriptor, the feature descriptor that represents a luminance change of a region including the feature point;
determine whether the marker is included in the one-dimensional image, based on a matching result between the registered descriptor and the observation descriptor; and
transmit a control signal to instruct the measurement device to start or stop the measurement.

8. A marker detection method executed by a computer, comprising:
storing, as a registered descriptor, a feature descriptor generated from an image in which a marker is captured, the marker including a plurality of colors arranged in one direction;
acquiring a one-dimensional image;
detecting a feature point from the one-dimensional image;
generating, as an observation descriptor, the feature descriptor that represents a luminance change of a region including the feature point; and
determining whether the marker is included in the one-dimensional image, based on a matching result between the registered descriptor and the observation descriptor.

9. (canceled)
